(19) United States
(12) Patent Application Publication
(10) Pub. No.: US 2021/0150494 A1
(43) Pub. Date: May 20, 2021

(54) SYSTEMS AND METHODS FOR A DUAL-READ SINGLE CARD SCANNER

(71) Applicant: Intercard, Inc., St. Louis, MO (US)

(72) Inventors: Scott D. Sherrod, St. Louis, MO (US); Anthony F. Giordano, St. Louis, MO (US); Richard Paul Hairsine, Ballwin, MO (US)

(21) Appl. No.: 16/951,960

(22) Filed: Nov. 18, 2020

Related U.S. Application Data
(60) Provisional application No. 62/936,778, filed on Nov. 18, 2019.

(51) Int. Cl. G06Q 20/04; G06Q 20/38; G06Q 20/24; G06Q 20/20

(52) U.S. Cl. CPC G06Q 20/047; G06Q 20/3829; G06Q 2220/00; G06Q 20/202; G06Q 20/24

(57) ABSTRACT

Systems and methods for a dual-read, single swipe card system. The systems and methods use a single card reader with circuitry and programming elements which receive a swipe of either a store card or a credit card, recognize the type of card being swiped, and execute a different payment processing procedure depending on the type of card being swiped. This process is carried out in a standards compliant manner. Transactions using either system maybe synchronized into a single database, regardless of which type of payment card was used for the transaction.

### CROSS-REFERENCE TO RELATED APPLICATIONS

This application claims the benefit of U.S. Prov. Pat. App. No. 62/936,778, filed Nov. 18, 2019, the entire disclosure of which is incorporated herein by reference.

### BACKGROUND OF THE INVENTION

### Field of the Invention

This disclosure is related to the field of payment card systems, and in particular, it relates to a dual-read, single swipe card system, which can recognize different types of payment cards and process each differently.

### Description of the Related Art

In prior decades, it was common for stores to issue paper gift certificates, or for gifts of cash to be exchanged using real currency. Now, it is increasingly popular instead to use a payment card. The ease, convenience, affordability, and durability of payment cards has led to the widespread adoption of a payment card standards throughout a number of industries. For example, a generic gift card functions like a credit card with a limited, pre-loaded balance. Similarly, in-store credit is now more commonly managed through a gift card system using magnetically striped payment cards issued by the particular store.

Such cards have also seen widespread adoption elsewhere. For example, hotels are now generally keyless, and instead issue a swipe card which is used to unlock the door to get into the room. Also, rewards programs now commonly use magnetic stripe cards to keep track of the number of points each consumer has accumulated. Payment cards have also become popular in casinos, video game arcades, and virtually any other environment in which a user may have a balance, whether it be currency, points, or otherwise, which it is desirable to monitor and track, particularly at a point of sale or use. College students, cruise line passengers, and resort visitors all use payment cards to acquire goods and services at their respective campuses, vessels, and resorts.

Despite this ease, credit card and store card payment economies are generally isolated from one another. This can be best understood by comparing how transactions are processed in a credit card company and a store card system. For a credit card, the card itself is generally issued by an “issuing bank,” which has a relationship with a payment network (e.g., Visa, American Express). When the credit card is used to make a retail purchase, the card is swiped through a magnetic reading head, and magnetically stored data is read from the stripe. This data includes a primary account number (PAN), which is usually associated with the issuing bank. The merchant accepting the payment sends transactional data to an acquiring bank for processing, which is usually the bank holding the seller's merchant account. This transactional date includes the PAN, along with the amount of the transaction. The acquiring bank contacts the issuing bank through the payment network to confirm the charge. The issuing bank checks the account balance of the account associated with the PAN to determine whether the account has a sufficient credit balance for the transaction, and transfers the funds if so. The acquiring bank then informs the retailer of the results of the process. The retailers then provide the goods or services. Alternatively, a commercial credit card payment processing company may be used, which negotiates the communication with the issuing bank. This processor may be the acquiring bank or a company retained by the acquiring bank.

The situation differs with economies. For example, in a casino, arcade, or other closed store card economy, the merchant usually issues the card, and does not send the transaction data to an acquiring bank or payment processor, but rather directly contacts a processing server for the specific store card.

Each type of card reader (credit card versus store card reader) can only read the specific type of card for which it is designed. That is, a credit card reader expects the industry standard format for a bank-issued credit card, and a store card reader expects whatever format the corresponding private economy store cards are designed to use.

This creates problems with vendors who wish to accept both types of cards. For example, a restaurant may wish to accept both its own rewards points and gift cards (e.g., store cards), as well as commercial credit cards, as payment for food and services. Frequent visitors tend to prefer their store cards, where they can accumulate benefits, but infrequent visitors will not want to go through the hassle of signing up for such a program, and would prefer to simply pay on a one-off basis with a credit card. This requires the venue to maintain two separate and distinct payment processing systems: one for the store cards and one for credit cards. This in turn can result in confusion, waste, and lost revenue as employees must be trained on two different systems and may occasionally scan the wrong card through the wrong kind of reader.

Further, the segregation of economies prevents the merchant from having a holistic and complete view of all transactions. That is, the merchant must reconcile credit card transactions with private economy transactions, both of which are generally stored in two different, non-compatible formats, in order to get a single view into all transactions.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a method for using a single payment card reader to process payment card transactions using multiple independent payment processing networks comprising: providing a first payment processing system comprising a computer server providing credit card payment processing services via a telecommunications network; providing a second payment card processing system of a retailer, comprising a retailer computer server providing store card processing services for store cards of the retailer via the telecommunications network; providing a payment card reader disposed in a retail location of the retailer; receiving, at the payment card reader, payment card data of a payment card in connection with a payment card transaction using the payment card, the payment card data having a format; the payment card reader determining a type of the payment card based on the format; only if the determined type of the payment card is a credit card: the payment card reader causing the payment card transaction to be processed by the first payment card processing system by transmitting to the first payment card processing system transaction data including the received payment card data; and only if the payment card transaction is approved by the first payment card processing system, the payment card reader causing the payment card transaction to also be processed by the second payment card processing system; and only if the determined type of the payment card comprises a store card of the retailer, the payment card reader causing the payment card transaction to be processed by the second payment card processing system.

In an embodiment of the method, the payment reader is one of a plurality of payment card readers.

In another embodiment of the method, before the payment card reader causing the payment card transaction to be processed by the first payment card processing system by transmitting to the first payment card processing system transaction data including the received payment card data, the payment card reader encrypting at least the payment card data.

In another embodiment of the method, the encrypting comprises asymmetric encryption using a one-time encryption key generated at the payment card reader, the one-time encryption key corresponding to a private decryption key of the first payment card processing system.

In another embodiment of the method, the payment card reader determining a type of the payment card based on the format comprises the card reader comparing the format of the received payment card data to a predefined format.

In another embodiment of the method, the payment card reader determining a type of the payment card based on the format comprises determining that the type is a store card if the format matches the predefined format.

In another embodiment of the method, the payment card reader determining a type of the payment card based on the format comprises determining that the type is a credit card if the format does not match the predefined format.

In another embodiment of the method, receiving, at the payment card reader, payment card data of a payment card comprises swiping the payment card past a magnetic read head of payment card reader.

In another embodiment of the method, receiving, at the payment card reader, payment card data of a payment card comprises receiving the payment card data via a short-range radio scanner.

Also described herein, among other things, is a payment card reader having a processor and a non-transitory, computer-readable medium having computer-executable program instructions thereon which, when executed by the processor, cause the payment card reader to perform the following steps: receiving payment card data of a payment card in connection with a payment card transaction using the payment card, the payment card data having a format; determining a type of the payment card based on the format; only if the determined type of the payment card comprises a credit card: causing the payment card transaction to be processed as a credit card transaction via a credit card payment network; only if the credit card transaction is approved, causing the payment card transaction to also be processed as a store card transaction via a store card payment processing system; and only if the determined type of the payment card comprises a store card of the retailer, the payment card reader causing the payment card transaction to be processed as a store card transaction via a store card payment processing system.

In an embodiment of the payment card reader, the program instructions, when executed by the processor, further cause the payment card reader to perform the following steps: before the causing the payment card transaction to be processed as a credit card transaction via a credit card payment network, encrypting the payment card data.

In another embodiment of the payment card reader, the encryption comprises asymmetric encryption using a one-time encryption key generated at the payment card reader, the one-time encryption key corresponding to a private decryption key of the credit card payment network.

In another embodiment of the payment card reader, determining a type of the payment card based on the format comprises the card reader comparing the format to a predefined format.

In another embodiment of the payment card reader, determining a type of the payment card based on the format comprises determining that the type is a store card if the format the predefined format.

In another embodiment of the payment card reader, determining a type of the payment card based on the format comprises determining that the type is a credit card if the format does not match the predefined format.

In another embodiment of the payment card reader, the payment card data is received at a magnetic read head of the payment card reader.

In another embodiment of the payment card reader, the payment card data is received via a short-range radio scanner.

### BRIEF DESCRIPTION OF THE DRAWINGS

FIG. 1 depicts a schematic diagram of an embodiment of a system for dual-reading payment cards as described herein.

FIG. 2 depicts a flow chart diagram of a method for dual-reading payment cards as described herein.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

At a high level of generality, the systems and methods described herein comprise a dual-read, single swipe card system. Generally, the systems and methods use a single card reader with circuitry and programming elements to allow the reader to receive a swipe of either a store card or a credit card, recognize the type of card being swiped, execute a different payment processing procedure depending on the type of card being swiped, and, in a standards compliant manner, synchronize transactions in either economy into a single database, regardless of which type of payment card was used for the transaction. These and other elements are described in further detail herein.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers. NAS and SAN, load balancers, and any other hardware capable of interacting with the systems and methods described herein in the matter of a conventional “computer.”

Two additional terms merit discussion with respect to one another for purposes of this disclosure: “credit card” and “store card.” A distinguishing feature between these two types of cards, as used in this disclosure, is the issuer of the card and how the card is used to access and use financial assets. A “credit card” for purposes of this disclosure should be understood as generally encompassing cards issued by financial institutions to businesses and consumers for general-purpose access to funds at a designated financial institution account. This includes, for example, a conventional credit card issued by an issuing bank, and the funds accessed are funds held by the bank and advanced as payment on behalf of the consumer, who then repays the issuing bank. This also includes, for example, debit cards, which may be used to make payments from demand accounts or other deposit accounts controlled by the cardholder at a designated financial institution. This may also include pre-paid credit cards, where a pre-paid balance is held by a financial institution and accessed via the card. Such cards may be “reloadable” with additional funds or not. A feature generally held in common with “credit cards” as used herein is that they are usually part of a credit card payment processing network (e.g., Visa, Mastercard, Discover), and are use-agnostic. That is, such cards use the credit card payment infrastructure to make payments and thus can be seamlessly accepted by virtually any merchant or retailer equipped to accept credit card payments, regardless of the specific type of card.

By contrast, the term “store card” as used herein refers primarily to stored-value money cards where the card tracks an amount of funds or other financial or financial-like assets (e.g., store credit, rewards points, etc.) which are usually issued by a retailer or group of retailers and redeemable only with those retailers. For example, a “gift card” can be purchased at major retailers, which contains a stored balance of in-store credit usable towards future purchases. However, the gift card will not be accepted by other stores for a number of reasons. For one, the gift card is purchased by paying the face value of the card to the store, and an unrelated retailer receives no remuneration in exchange for honoring the gift card. Further, even if a third party retailer wanted to honor the card, there is no way for the third party to process it because, unlike a commercial payment network which accepts subscribers from the public, a store card is issued by the store and does not participate in the payment network, and thus the third party retailer has no authentication or access to the issuing store's payment systems to process consumer uses of the card elsewhere. Some non-exhaustive, non-limiting examples of “store cards” include retailer-specific prepaid cards such as gift and refund cards, as well as payment cards used as a closed-economy cash substitute, such as casinos, cruise ships, hotels and resorts, college campuses, arcades, indoor playgrounds, and so forth.

It should be noted that, in some instances, gift cards and the like may be implemented by leveraging the formatting standards and transactional procedures of credit payment networks. In such instances, although the payment card is, from the consumer's point of a view a “store card,” functionally, transactions using it are carried out in the same manner as a credit card. The payment processing data stored on the card simply routes the transaction back to the store's own payment processing systems, or, stores may partner with a credit card payment network for the processing of such cards. In such instances, the cards are “credit cards” for purposes of this disclosure, because the associated readers need only be programmed to recognize and process transactions in accordance with data formatting standards and transactional rules of the credit card payment system.

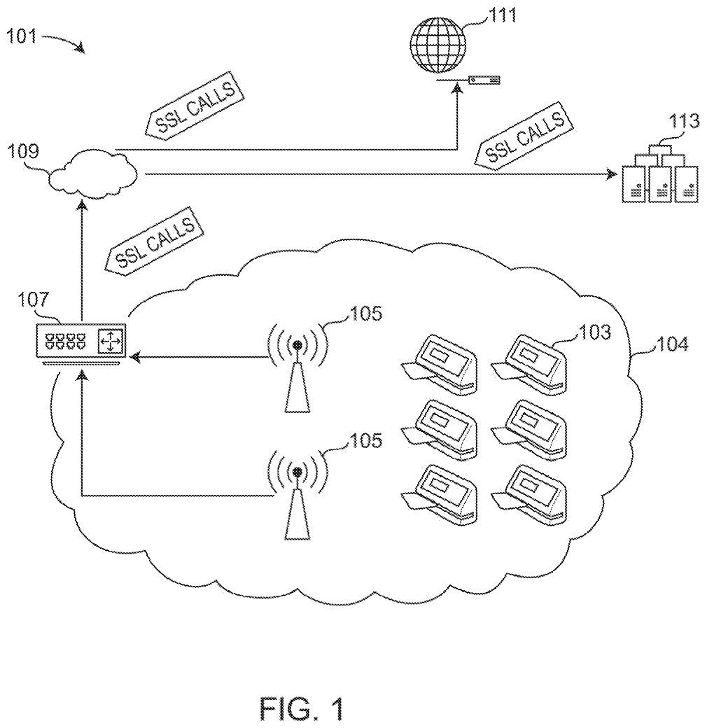

FIG. 1 depicts an embodiment of a system according to the present disclosure. In the depicted embodiment of FIG. 1, the system (101) comprises one or more payment card readers (103), deployed in a retail location. The depicted readers (103) are generally magnetic swipe readers, but other types of readers are possible, such as short-range radio scanners (e.g. RFID, Bluetooth, 802.11 and 802.15 protocols), in wired or wireless communication via a local area network (104), and communicating with a wide area network (109) via a modem or router (107). Typically, such readers (103) are Wi-Fi-enabled and communicate wirelessly with the router (107) either directly via one or more wireless access points (105). The router (107) often is also in communication with one or more external computer systems via the wide area network (109). In the depicted embodiment, the wide area network (109) is the public Internet.

An element of the system (101) is that the readers (103) can communicate with both an acquiring blank/payment card processing system (111) (referred to herein as a “clearing house” for brevity), and with a store card payment processing system (113). Depending upon which type of card is swiped using the reader (103), software in the reader (103) selects whether a clearing house (111) or store card system (113) should be used, or both, and in what order.

Generally, if the reader (103) detects that the card is a credit card, a transaction is first processed through a clearing house (111), and, if successful, a secondary transaction is then processed via the store card system (113). In this way, the transaction can be processed using the credit card system, but a record of the transaction amount, along with other useful data such as the date and time, are also received at the store card system (113).

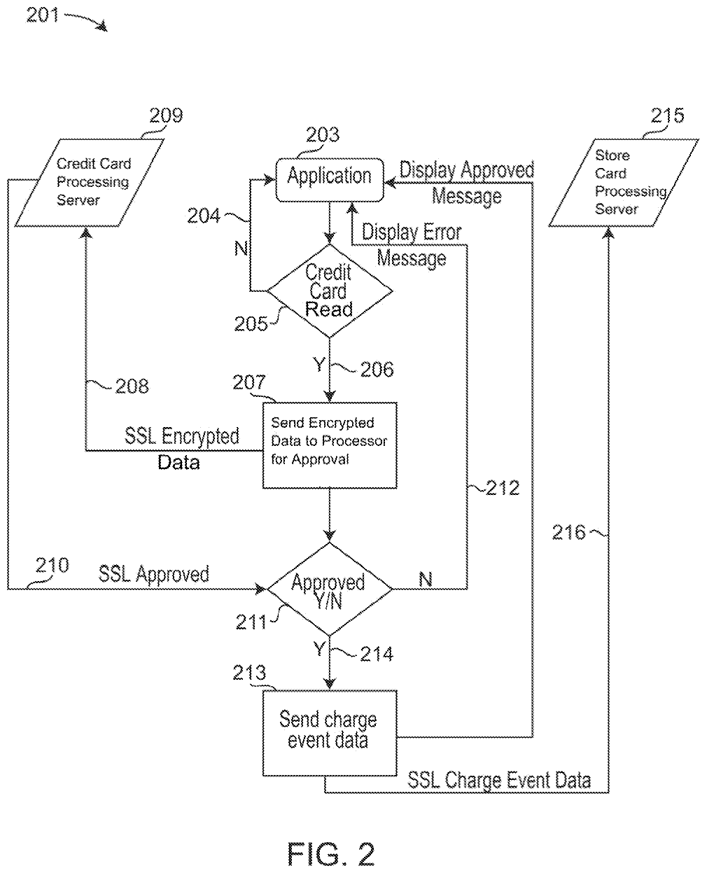

FIG. 2 depicts an embodiment of a method (201) as described herein. As can be seen in the depicted embodiment of FIG. 2, the method (201) comprises with an application (203) installed on a Wi-Fi card reader (103). The application (203) is loaded into memory and executed by the processor. A consumer uses a payment card to swipe (205) through the card reader (103) to purchase a good or service. If the swipe is unsuccessful (204), then the user must swipe again. If the swipe properly reads (206) the data off of the card, the software on the reader (103) examines the data read from the magnetic stripe to determine whether the card is a credit card, or a store card. This is generally done by examining the format of the received data, which differs for a credit card as opposed to store card.

If it is a credit card, then the necessary data (208) to process the payment request is sent (207) to the clearing house (111). The clearing house will then conduct ordinary credit card processing (209) to confirm the transaction. This may include, for example, contacting the issuing bank for the payment card, determining if there is an active account with a sufficient balance for the requested amount of the transaction, and receiving an approval or denial from the issuing bank. The result of this process is then returned (210) the reader, which examines whether the transaction was approved or not (211). If the transaction is declined, the application displays (212) an error message and returns to its starting state (203). If the transaction is accepted (214), then a secondary charge event takes place (213). Appropriate transaction data is sent (216) to the store card payment system (113) for processing (215). An approve message is displayed to the user via the application, and a second transaction is sent to the private economy server (215) for processing there.

An aspect of the present disclosure is that the readers (103) directly contact the clearing house (III) to obtain authorization for the transaction for payments using a credit card. As shown in the depicted embodiment of FIG. 1, this is done through use of a telecommunications network, such as a combination of a local area network (104) and wide area network (109). Another aspect of the present disclosure is that the readers (103) directly contact the store card system (113) to report the authorization if approved by the clearing house system (11l). As shown in the depicted embodiment of FIG. 1, this is ordinarily done through use of a telecommunications network, such as a combination of a local area network (104) and wide area network (109). However, in some embodiments, only the local area network (104) may be used, such as where the store card payment system (113) is an on-premises server system.

Another aspect of the system is that the readers (103) are configured and adapted to determine what type of card has been swiped. For example, the reader may comprise a controller or CPU which executes software or program instructions which examine the data read from the magnetic stripe of the payment card and determine from that data whether the card swiped is a credit card or store card. The reader (103) may be further configured in with settings for connecting to and processing the payment via the clearing house system (Il). Such settings may include, but are not necessarily limited to, a remote host or IP address to connect to, authentication credentials and/or certificates, security and/or encryption keys or certificates, and so forth. The reader (103) may be further configured with settings for connecting to and processing the payment via the store card payment system (113). Such settings may include, but are not necessarily limited to, a remote host or IP address to connect to, authentication credentials and/or certificates, security and/or encryption keys or certificates, and so forth.

Modern credit card security systems add a layer of challenge to this system in that modern credit card readings incorporate asymmetric encryption via a one-time use encryption key at the read head, which key is usually generated by the clearing house system (111). That is, when a payment card is swiped, the data is automatically encrypted via a one-use encryption key, with the corresponding decryption key in the custody of the clearing house (111). This system is used for point-to-point encryption in the payment card industry. However, in the present disclosure, if the swiped card is not a credit card, the encryption step is not necessary and in fact renders the system unusable because there is no corresponding decryption key generated at the store card payment system (113). That is, the encrypted information read off the card by the reader (103) cannot be decrypted by the store card payment system (113). As such, one aspect of the present disclosure is that the reader (103) is adapted to apply encryption only if the swiped card is determined to be a credit card. If the swiped card is determined to instead be a store card, then the read data from the magnetic stripe is returned in plain text or clear text (i.e., not encrypted). This clear text data car then be sent to the store card payment system (113) only, as there is no need to use the clear housing system (111) with a store card. In an embodiment, the determination of whether the data read from the card is encrypted or not is determined by comparing the structure of the received data with a predefined format. If the received data matches the predefined format, then the received data is in plaintext and card is a store card. If the received data does not match the predefined format, then the received data is encrypted and the card is a credit card.

Another aspect of the present disclosure is that encryption must be preserved for credit cards in order to adhere to payment card security standards. This in turn means that in the case of a credit card, the primary account number (PAN) read from the card is never made available in plaintext. Due to the nature of the type of encryption used, each swipe of the card will produce a different encrypted data packet, which means there is no unique identifier for the customer in the data. The reader (103) can still transmit the approved credit card transaction to the store card payment system (113) along with transaction data (e.g., timestamp, amount, nature of purchase).

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A method for using a single payment card reader to process payment card transactions using multiple independent payment processing networks comprising:
providing a first payment processing system comprising a computer server providing credit card payment processing services via a telecommunications network;
providing a second payment card processing system of a retailer, comprising a retailer computer server providing store card processing services for store cards of said retailer via said telecommunications network;
providing a payment card reader disposed in a retail location of said retailer;
receiving, at said payment card reader, payment card data of a payment card in connection with a payment card transaction using said payment card, said payment card data having a format;
said payment card reader determining a type of said payment card based on said format;
only if said determined type of said payment card is a credit card:
said payment card reader causing said payment card transaction to be processed by said first payment card processing system by transmitting to said first payment card processing system transaction data including said received payment card data; and
only if said payment card transaction is approved by said first payment card processing system, said payment card reader causing said payment card transaction to also be processed by said second payment card processing system; and
only if said determined type of said payment card comprises a store card of said retailer, said payment card reader causing said payment card transaction to be processed by said second payment card processing system.

2. The method of claim 1, wherein said payment reader is one of a plurality of payment card readers.

3. The method of claim 1, further comprising, before said payment card reader causing said payment card transaction to be processed by said first payment card processing system by transmitting to said first payment card processing system transaction data including said received payment card data, said payment card reader encrypting at least said payment card data.

4. The method of claim 3, wherein said encrypting comprises asymmetric encryption using a one-time encryption key generated at said payment card reader, said one-time encryption key corresponding to a private decryption key of said first payment card processing system.

5. The method of claim 1, wherein said payment card reader determining a type of said payment card based on said format comprises said card reader comparing the format of said received payment card data to a predefined format.

6. The method of claim 5, wherein said payment card reader determining a type of said payment card based on said format comprises determining that said type is a store card if said format matches said predefined format.

7. The method of claim 5, wherein said payment card reader determining a type of said payment card based on said format comprises determining that said type is a credit card if said format does not match said predefined format.

8. The method of claim 1, wherein said receiving, at said payment card reader, payment card data of a payment card comprises swiping said payment card past a magnetic read head of payment card reader.

9. The method of claim 1, wherein said receiving, at said payment card reader, payment card data of a payment card comprises receiving said payment card data via a short-range radio scanner.

10. A payment card reader having a processor and a non-transitory, computer-readable medium having computer-executable program instructions thereon which, when executed by said processor, cause said payment card reader to perform the following steps:
receiving payment card data of a payment card in connection with a payment card transaction using said payment card, said payment card data having a format;
determining a type of said payment card based on said format;
only if said determined type of said payment card comprises a credit card:
causing said payment card transaction to be processed as a credit card transaction via a credit card payment network;
only if said credit card transaction is approved, causing said payment card transaction to also be processed as a store card transaction via a store card payment processing system; and
only if said determined type of said payment card comprises a store card of said retailer, said payment card reader causing said payment card transaction to be processed as a store card transaction via a store card payment processing system.

11. The payment card reader of claim 10, wherein said program instructions, when executed by said processor, further cause said payment card reader to perform the following steps:
before said causing said payment card transaction to be processed as a credit card transaction via a credit card payment network, encrypting said payment card data.

12. The payment card reader of claim 11, wherein said encryption comprises asymmetric encryption using a one-time encryption key generated at said payment card reader, said one-time encryption key corresponding to a private decryption key of said credit card payment network.

13. The payment card reader of claim 10, wherein said determining a type of said payment card based on said format comprises said card reader comparing said format to a predefined format.

14. The payment card reader of claim 13, wherein said determining a type of said payment card based on said format comprises determining that said type is a store card if said format said predefined format.

15. The payment card reader of claim 14, wherein said determining a type of said payment card based on said format comprises determining that said type is a credit card if said format does not match said predefined format.

16. The payment card reader of claim 10, wherein said payment card data is received at a magnetic read head of said payment card reader.

17. The payment card reader of claim 10, wherein said payment card data is received via a short-range radio scanner.
